(19) United States
(12) Patent Application Publication
(10) Pub. No.: US 2018/0065464 A1
(43) Pub. Date: Mar. 8, 2018

(54) OFF-HIGHWAY VEHICLE

(71) Applicant: YAMAHA MOTOR CORPORATION, USA, Cypress, CA (US)

(72) Inventor: Jeffrey E. PALHEGYI., El Cajon, CA (US)

(21) Appl. No.: 15/691,978

(22) Filed: Aug. 31, 2017

Related U.S. Application Data
(60) Provisional application No. 62/383,055, filed on Sep. 2, 2016.

(51) Int. Cl. B60K 5/04; B60K 17/04; B60B 35/00; B60K 11/04; B60K 15/063; B60R 21/13; B60K 13/04; B60G 3/18

(52) U.S. Cl. CPC B60K 5/04; B60K 17/04; B60B 35/004; B60K 11/04; B60K 13/02; B60R 21/13; B60K 13/04; B60G 3/18; B60K 15/063

(57) ABSTRACT

An off-highway vehicle is provided with a frame, a plurality of wheels, a seat, a drive source and a drivetrain. The frame has a longitudinal center plane dividing the frame into first and second lateral sides. The seat and the drive source are primarily located on opposite lateral sides of the frame. The drive source has an output shaft oriented in a vehicle widthwise direction. The output shaft is arranged forward of a rearmost end of the seat and rearward of a frontmost end of the seat as viewed in a top plan view. The output shaft and an axle of a drive wheel are located on different axes. The drivetrain operatively couples the output shaft to the axle to transmit a drive force from the output shaft to the axle.

### CROSS-REFERENCE TO RELATED APPLICATIONS

This application claims the benefit of U.S. Provisional Application No. 62/383,055, filed on Sep. 2, 2016. The entire disclosure of U.S. Provisional Application No. 62/383,055 is hereby incorporated herein by reference.

### BACKGROUND

### Field of the Invention

The present invention generally relates to the field of off-highway vehicles. More specifically, the present invention relates to an off-highway vehicle having an improved arrangement of components.

### Background Information

Generally, off-highway vehicles related to the present invention are designed to be operated on asphalt circuits and/or dirt road track. The design of an off-highway vehicle can be quite different from vehicles designed for driving on paved roads. A small off-highway vehicle includes a frame that is supported by three or four wheels. In the case of a four-wheeled vehicle, a drive source such as an internal combustion engine is utilized to drive one or more of the wheels. Typically, the drive source will be configured to drive two of the wheels or all four of the wheels. Typically, the engine is provided with a transmission. The transmission transfers power to an output shaft from a crankshaft of the engine. The output shaft drives the wheels through a drivetrain.

### SUMMARY

Generally, the present disclosure is directed to various features of an off-highway vehicle. In driving various off-highway vehicles, it has been found that the balance of the vehicle significantly affects the handling of the off-highway vehicle. Accordingly, one object of the present disclosure is directed to improving the balance of an off-highway vehicle.

In accordance with one aspect of the present disclosure, an off-highway vehicle is provided that basically comprises a frame, a plurality of wheels, a seat, a drive source and a drivetrain. The frame has a longitudinal center plane extending in a vehicle lengthwise direction and dividing the frame into a first lateral side and a second lateral side. The wheels support the frame. At least one of the wheels is a drive wheel. The seat is supported by the frame. The seat is located primarily on the first lateral side of the frame. The drive source is supported by the frame. The drive source is located primarily on the second lateral side of the frame. The drive source has an output shaft oriented in a vehicle widthwise direction. The output shaft is arranged forward of a rearmost end of the seat and rearward of a frontmost end of the seat as viewed in a top plan view. The output shaft and an axle of the drive wheel are located on different axes. The drivetrain operatively couples the output shaft to the drive wheel to transmit drive force from the output shaft to the drive wheel.

Also, other features, aspects and advantages of the disclosed off-highway vehicle will become apparent to those skilled in the field of manufacturing off-highway vehicles from the following detailed description, which, taken in conjunction with the annexed drawings, discloses several illustrative embodiments of an off-highway vehicle with various features.

### BRIEF DESCRIPTION OF THE DRAWINGS

Referring now to the attached drawings which form a part of this original disclosure:

FIG. 1 is a perspective view of an off-highway vehicle in accordance with one illustrative embodiment;

FIG. 2 is a left side elevational view of the off-highway vehicle illustrated in FIG. 1;

FIG. 3 is a top plan view of the off-highway vehicle illustrated in FIGS. 1 and 2;

FIG. 4 is a top plan view, similar to FIG. 3, of the off-highway vehicle, but with the vehicle body and interior panels removed from the frame;

FIG. 5 is a left side elevational view, similar to FIG. 2, of the off-highway vehicle, but with the vehicle body and interior panels removed from the frame;

FIG. 6 is a top plan view, similar to FIGS. 3 and 4, of the off-highway vehicle, but with the vehicle body, the interior panels and the frame removed for purposes of illustration;

FIG. 7 is a partial rear elevational view of the off-highway vehicle with the vehicle body removed from the frame;

FIG. 8 is a partial front elevational view of the off-highway vehicle with the vehicle body removed from the frame;

FIG. 9 is a perspective view of the frame of the off-highway vehicle illustrated in FIGS. 1 to 3;

FIG. 10 is a left side elevational view of the frame of the off-highway vehicle illustrated in FIGS. 1 to 3;

FIG. 11 is a top plan view of the frame of the off-highway vehicle illustrated in FIGS. 1 to 3;

FIG. 12 is a front end elevational view of the frame of the off-highway vehicle illustrated in FIGS. 1 to 3; and

FIG. 13 is a rear end elevational view of the frame of the off-highway vehicle illustrated in FIGS. 1 to 3.

It should be noted that these figures are intended to illustrate the general characteristics of methods, structure and/or materials utilized in certain illustrative embodiment and to supplement the written description provided below. These figures are to reduce scale of the actual off-highway vehicle, but may not precisely reflect the precise structural or performance characteristics of any given embodiment. However, the dimensional relationships and the arrangement of the parts of the off-highway vehicle are accurately depicted.

### DETAILED DESCRIPTION OF EMBODIMENTS

Selected embodiments will now be explained with reference to the drawings. It will be apparent to those skilled in the off-highway vehicle field from this disclosure that the following descriptions of the embodiments are provided for illustration only and not for the purpose of limiting the invention as defined by the appended claims and their equivalents. Like reference numerals in the drawings denote like similar or identical elements or features, and thus the descriptions of the similar or identical elements or features may be omitted in later embodiments.

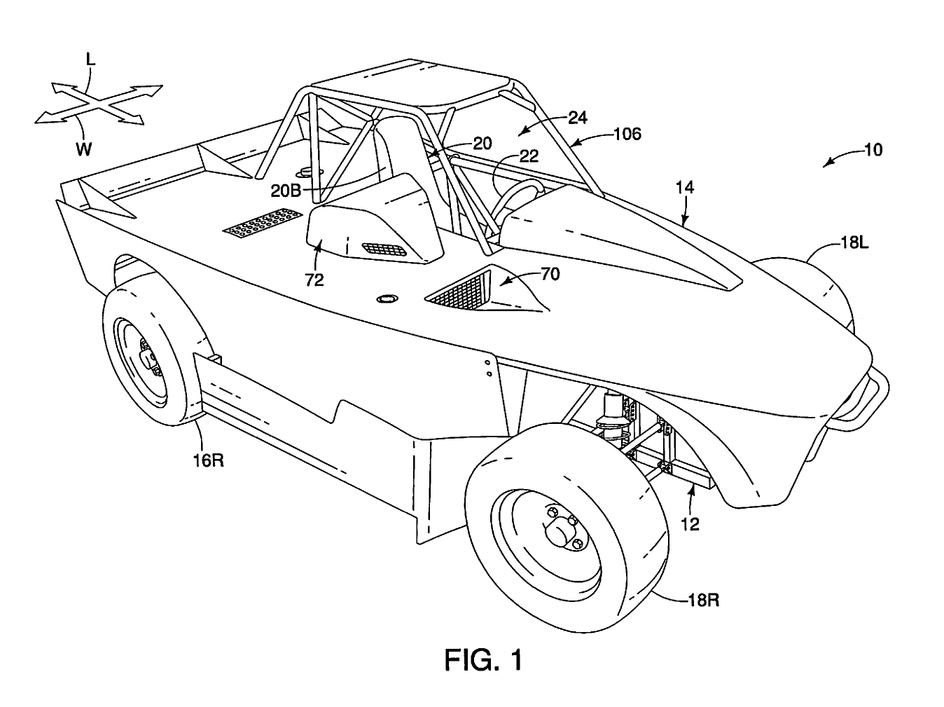

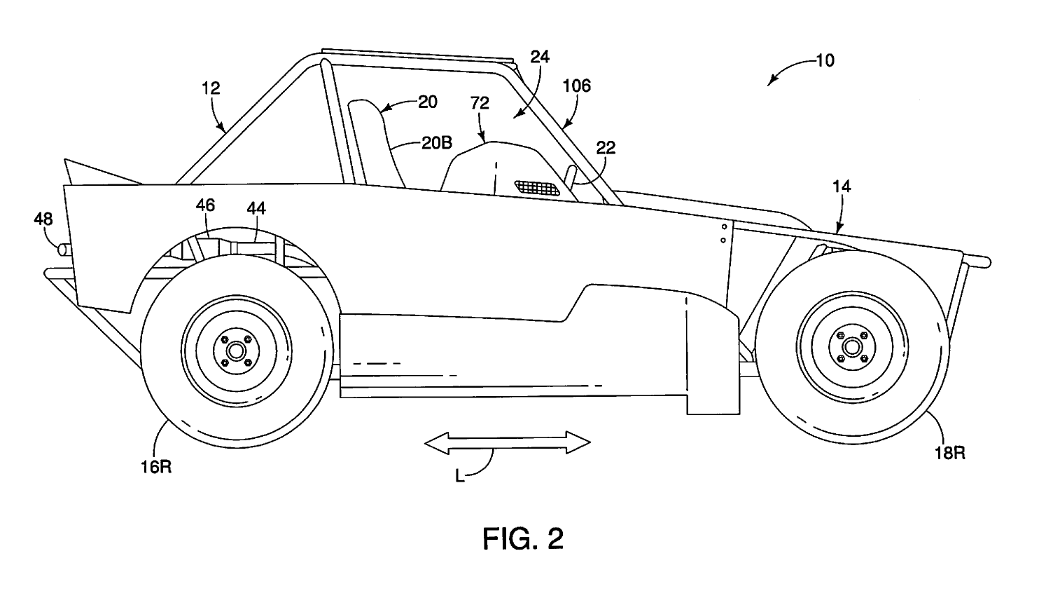

Referring initially to FIGS. 1 to 3, an off-highway vehicle 10 is illustrated in accordance with one illustrative embodiment. Here, the off-highway vehicle 10 is a small off-highway vehicle for a single person. As used herein, the term “off-highway vehicle” refers to a vehicle that is not street legal (i.e. equipped and licensed for use on public roads). In the illustrated embodiment, the off-highway vehicle 10 is especially designed as a dirt track vehicle for racing on a dirt track. In other words, in the illustrated embodiment, the off-highway vehicle 10 can further be classified as an off-road vehicle”. Generally, as used herein, the term “off-road vehicle” refers to a vehicle primarily designed for driving on unpaved and uneven surfaces. Of course, off-road vehicles such as the off-highway vehicle 10 illustrated herein can be also driven on paved surfaces. However, the term “off-road vehicle” does not include large vehicles that are designed for primarily driving on paved surfaces. As explained below, the off-highway vehicle 10 has a particular arrangement that provides for a well-balanced off-highway vehicle in both a vehicle lengthwise direction L and a vehicle widthwise direction W.

The off-highway vehicle 10 basically comprises a frame 12, a vehicle body 14, a pair of rear wheels 16R and 16L, a pair of front wheels 18R and 18L and a seat 20. In some applications of the off-highway vehicle 10, the vehicle body 14 can be omitted. Also, in some applications of the off-highway vehicle 10, only three wheels can be provided instead of four wheels as in the illustrated embodiment. The off-highway vehicle 10 further comprises many other conventional vehicle components, such as an accelerator pedal, a brake system, etc. that are typically provided on off-highway vehicles. However, for the sake of brevity, only those vehicle components needed to understand the present invention will be illustrated and/or discussed herein.

The off-highway vehicle 10 further comprises a steering wheel 22 operatively connected to the front wheels 18R and 18L by a steering column 23 for turning the front wheels 18R and 18L in a conventional manner. In some applications, a control stick can be used in place of the steering wheel 22. Other suitable steering devices also can be used, such as, without limitation, a handlebar, one or more push-buttons, one or more foot pedals and the like.

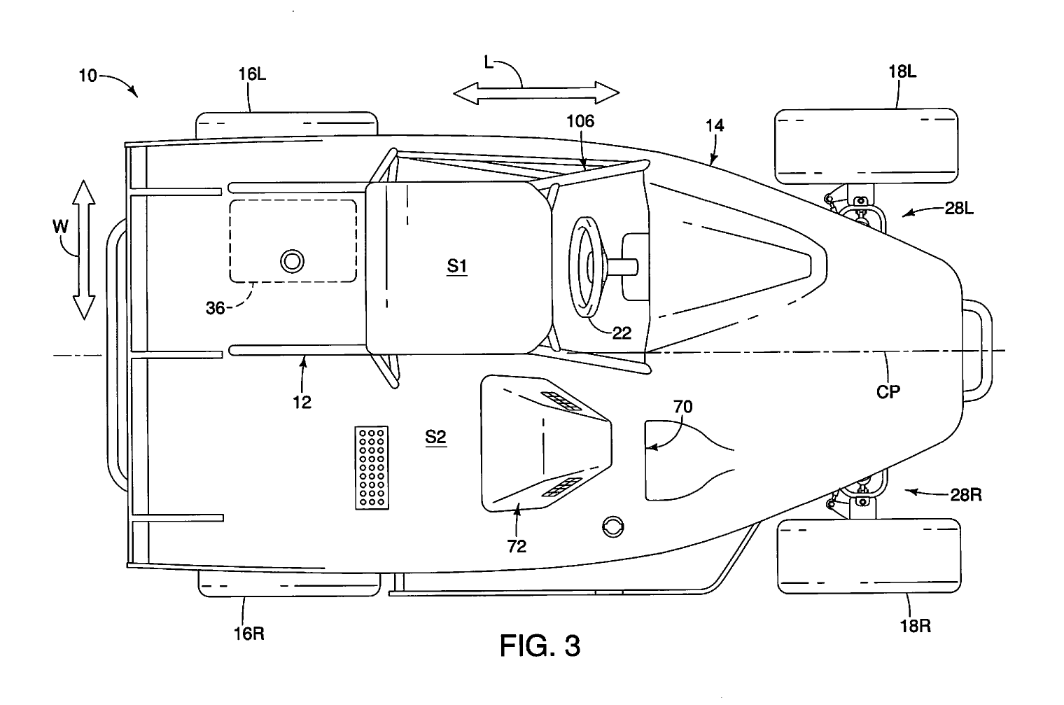

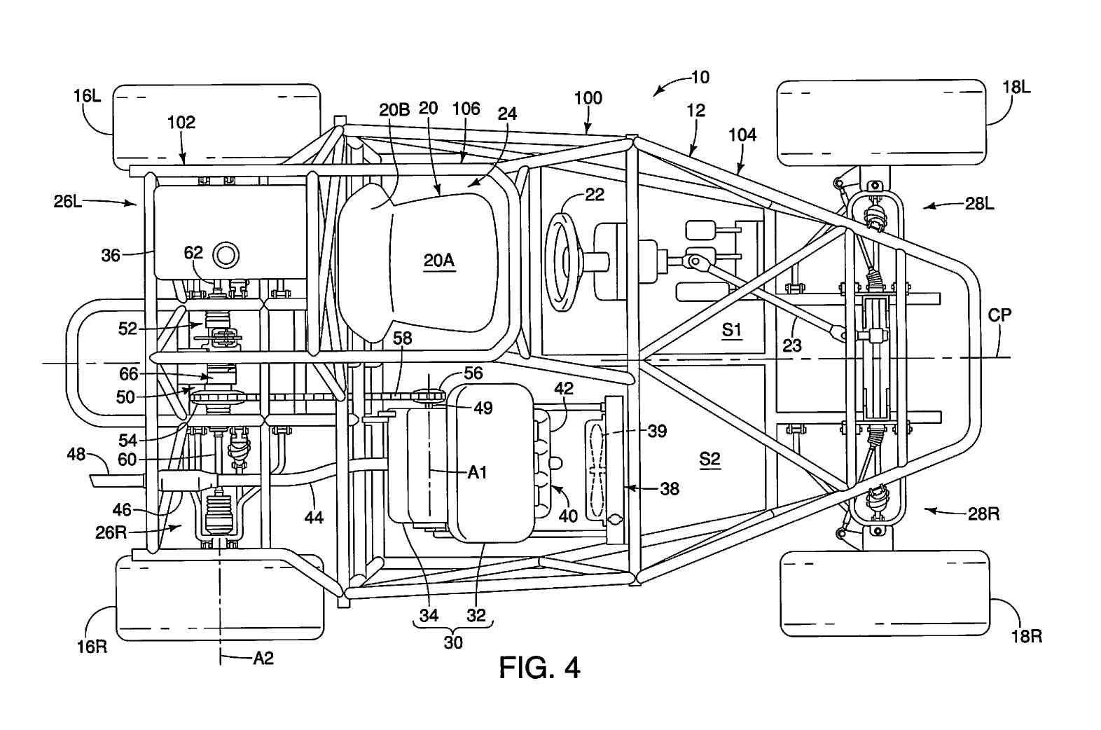

In the following description, the terms “front” and “forward” refer to a direction in which the driver looks straight when seated on the seat 20. Also in the following description, the terms “rear,” “rearward” and “backward” refer to a direction opposite to the front or forward direction. Further in the following description, the term “lateral side” refer to a portion of the off-highway vehicle 10 that is one or the other side of a center longitudinal plane that bisect the off-highway vehicle 10 halfway between the wheels 16R, 16L, 18R and 18L. Thus, as seen in FIGS. 3 and 4, the frame 12 has the longitudinal center plane CP extending in the vehicle lengthwise direction L and dividing the frame 12 into a first lateral side S1 and a second lateral side S2.

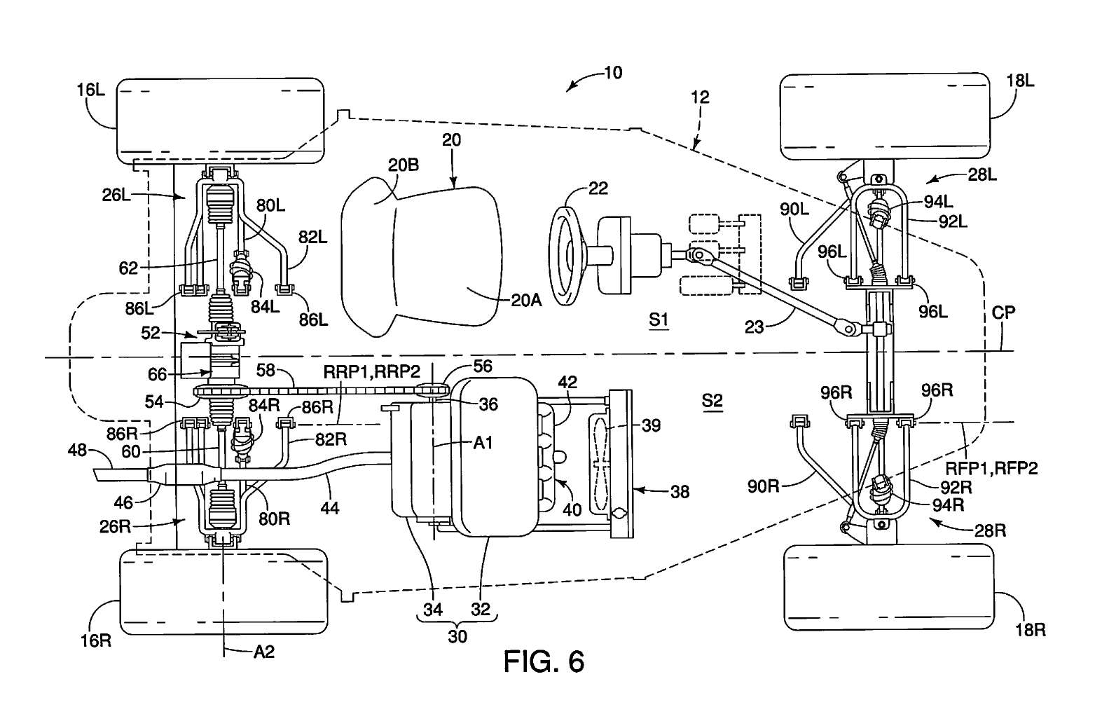

The vehicle body 14 is supported on the frame 12. The vehicle body 14 define a cabin 24 that is located only on the first lateral side S1 of the frame 12. The wheels 16R, 16L, 18R and 18L support the frame 12 for movement. The seat 20 is also supported on the frame 12. The seat 20 is located primarily on the first lateral side S1 of the frame 12. More preferably, the seat 20 is located entirely on the first lateral side S1 of the frame 12. The seat 20 includes a seat cushion 20A and a seat back 20B. The seat cushion 20A extends generally in a horizontal orientation, while the seat back 20B extends generally in a vertical orientation from a rear edge of the seat cushion 20A. The seat cushion 20A has a forward edge that defines a frontmost end of the seat 20 as viewed in a top plan view as seen in FIG. 6. The seat back 20B has a rear top edge that defines a rearmost end of the seat 20 as viewed in a top plan view as seen in FIG. 6.

Here, the front wheels 18R and 18L are steerable wheels for changing the travel path of the off-highway vehicle 10, while the rear wheels 16R and 16L are drive wheels for propelling the off-highway vehicle 10 along the ground. Of course, it will be apparent from this disclosure that one or more of the wheels 16R, 16L, 18R and 18L can be a drive wheel. For example, only one of the rear wheels 16R and 16L can be a drive wheel, or only one of the front wheels 18R and 18L can be a drive wheel. Also for example, both of the front wheels 18R and 18L can be drive wheels, and the rear wheels 16R and 16L can be either drive wheels or not. In any case, at least one of the wheels 16R, 16L, 18R and 18L is a drive wheel. The rear wheels 16R and 16L are preferably are coupled to frame 12 via a pair of rear suspension mechanisms 26R and 26L, respectively. Each of the rear suspension mechanisms 26R and 26L is swingably (up and down), and independently suspends the associated one of the rear wheels 16R and 16L. Similar, the front wheels 18R and 18L are preferably are coupled to frame 12 via a pair of front suspension mechanisms 28R and 28L, respectively. Each of the front suspension mechanisms 28R and 28L is swingably (up and down), and independently suspends the associated one of the front wheels 18R and 18L. Thus, the illustrated off-highway vehicle 10 preferably includes a four-wheel independent suspension.

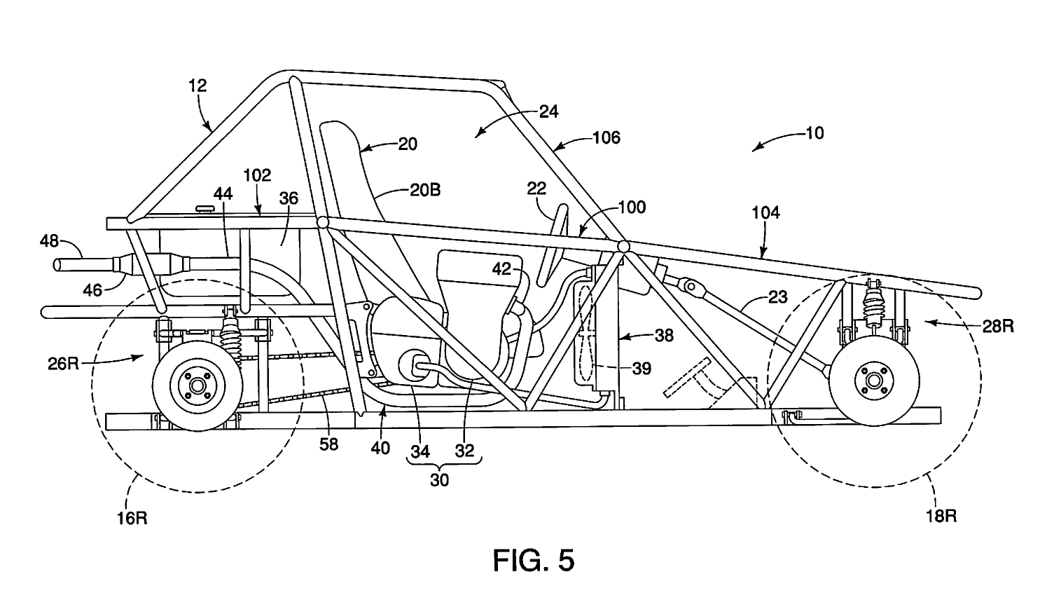

As seen in FIGS. 4 to 6, the off-highway vehicle 10 further comprises a drive source 30 for driving the rear wheels 16R and 16L. The drive source 30 is located primarily on the second lateral side S2 of the frame 12. More preferably, the drive source 30 is located entirely on the second lateral side S2 of the frame 12. Here, the drive source 30 includes an internal combustion engine 32 and a gearbox 34. More specifically, the engine 32 is an in-line four-cylinder engine in which the gearbox 34 is integrated with the engine 32 similar to a conventional motorcycle engine. Thus, the off-highway vehicle 10 further comprises a fuel tank 36 for supplying fuel to the engine 32 of the drive source 30 in a conventional manner. The fuel tank 36 is arranged rearward of the seat 20. The fuel tank 36 is arranged on the first lateral side S1 of the longitudinal center plane CP. The fuel tank 36 is surrounded by the frame 12. Alternatively, the drive source 30 could be an electric motor.

Preferably, the off-highway vehicle 10 further comprises a radiator 38 for cooling the engine 32 of the drive source 30 in a conventional manner. Here, a fan 39 is preferably provided on the rearward facing side of the radiator 38. The fan 39 sucks air through the radiator 38 towards the engine 32. In this way, the coolant in the radiator 38 is cooled. Also the air from the fan 39 further aids in cooling the engine due to the close proximity of the fan 39 to the engine 32. The radiator 38 is disposed forward of a front side of the drive source 30, and is aligned in the vehicle lengthwise direction with the drive source 30.

Further, the off-highway vehicle 10 comprises an exhaust system 40 for conveying the exhaust out of the vehicle body 14. The exhaust system 40 includes a portion that extends generally rearward from a rear side of the drive source 30. Preferably, the exhaust system 40 includes an exhaust manifold 42, an exhaust pipe 44, a muffler 46 and a tail pipe 48. The exhaust manifold 42 is provided on the front side of the engine 32. The exhaust pipe 44 extends downward from the exhaust manifold 42 downward and then extends underneath the engine 32 and the gearbox 34. The exhaust pipe 44 further extends reward and upward from the rear side of the drive source 30 to the rear end of the frame 12. The muffler 46 is provided between the exhaust pipe 44 and the tail pipe 48 for decreasing the amount of noise emitted by the exhaust of the engine 32 of the drive source 30 in a conventional manner. The muffler 46 is disposed rearward of the seat 20.

Basically, the engine 32 has a crankshaft (not shown) that is operatively coupled to the gearbox 34 with a clutch (not shown) operatively disposed to selectively engage and disengage the engine 32 from the gearbox 34. The gearbox 34 has an output shaft 49 for outputting the drive force from the engine 32. The output shaft 49 is oriented in the vehicle widthwise direction W. The output shaft 49 is arranged forward of a rearmost end of the seat 20 and rearward of a frontmost end of the seat 20 as viewed in a top plan view. The output shaft 49 extends from a side of the drive source 30 near the longitudinal center plane CP. More preferably, the output shaft 49 faces towards the longitudinal center plane CP.

The off-highway vehicle 10 further comprises a drivetrain 50 for transmitting the drive force from the output shaft 49 to the rear wheels 16R and 16L. In the illustrated embodiment, the drivetrain 50 includes an endless band drive, which can be either a chain drive or a belt drive. In particular, the drivetrain 50 includes a rear drive axle 52, a rear sprocket 54, a front sprocket 56 and a chain 58 (i.e., an endless band). The rear sprocket 54 is fixedly mounted to the rear drive axle 52. The front sprocket 56 is fixedly mounted to the output shaft 49. The chain 58 is engaged with the rear sprocket 54 and the front sprocket 56. In this way, the drivetrain 50 operatively couples the output shaft 49 to the rear drive axle 52 to transmit drive force from the output shaft 49 to the rear drive axle 52. As a result of this arrangement, the output shaft 49 and an axle of the drive wheels 16R and 16L are located on different axes A1 and A2, respectively. The rear drive axle 52 of the drive wheels 18R and 18F is adjustable in the vehicle lengthwise direction to adjust tension in the chain 58 (i.e., the endless band) of the endless band drive. In the illustrated embodiment, the rear drive axle 52 basically includes a right drive shaft 60, a left drive shaft 62 and a center drive shaft 64.

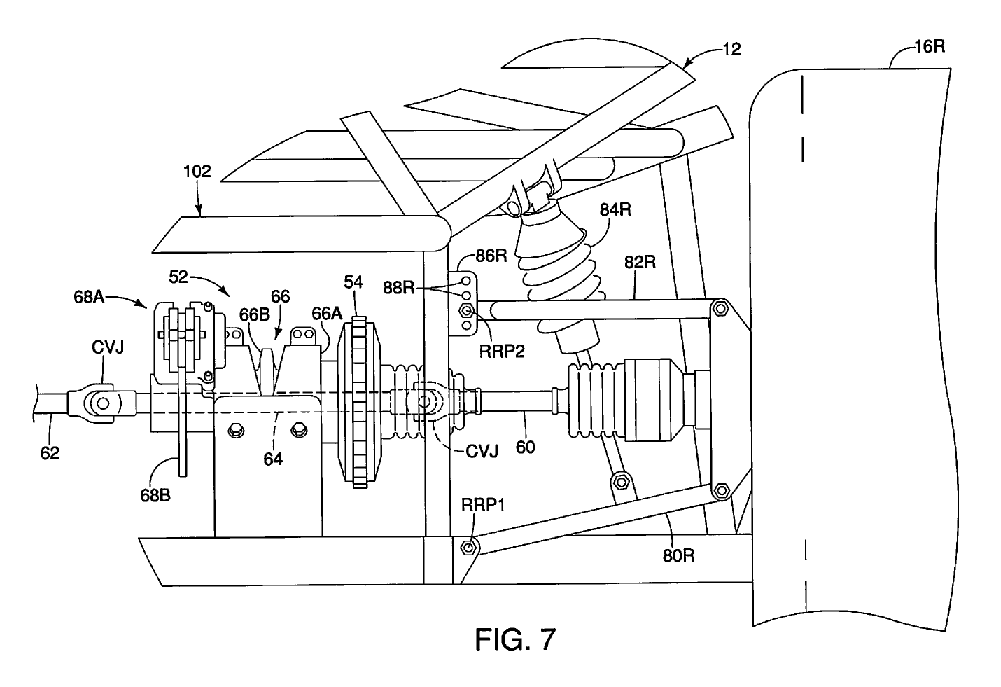

As seen in FIG. 7, each of the center drive shaft 64 is coupled to an inboard end of the right and left drive shafts 60 and 62 by a constant variable joint CVJ. The center drive shaft 64 is supported by an eccentric bearing assembly 66. The right drive shaft 60 has an outboard end coupled to the rear wheel 16R and an inboard end coupled to a right side eccentric bearing of the eccentric bearing assembly 66. The left drive shaft 62 has an outboard end coupled to the rear wheel 16L and an inboard end coupled to a left side eccentric bearing of the eccentric bearing assembly 66. The rear sprocket 54 is fixedly mounted to the center drive shaft 64.

The eccentric bearing assembly 66 is configured to be adjustable in the vehicle lengthwise direction L to adjust the tension on the chain 58. In particular, the eccentric bearing assembly 66 includes an outer housing 66A (i.e., a clamping member) and an inner housing 66B (i.e., an eccentric bearing carrier). The outer housing 66A is fixed to the frame 12, while the inner housing 66B is disposed inside of the outer housing 66A. Basically, the inner housing 66B is rotated inside of the outer housing 66A and then clamped in place to adjust the tension on the chain 58. In particular, the outer housing 66A is basically a split C-shaped clamp that has a split cylindrical portion with the ends of the split cylindrical portion between fastened together by a pair of clamping bolts. Thus, by tightening the clamping bolts, the split cylindrical portion squeezes and secures the inner housing 66B inside the outer housing 66A to prevent rotation of the inner housing 66B with respect to the outer housing 66A. The inner housing 66B has a generally cylindrical outer surface that is rotatably engaged with the split cylindrical portion of the outer housing 66A while the clamping bolts of the outer housing 66A are loose. The inner housing 66B has an eccentric bore that rotatably supports the center drive shaft 64. The inner housing 66B preferably includes a bearing having an inner race defining the eccentric bore. Thus, by rotating the inner housing 66B inside the split cylindrical portion of the outer housing 66A, the center drive shaft 64 is move in the vehicle lengthwise direction L with respect to the frame. Then, by tightening the bolts of the of the outer housing 66A, he split cylindrical portion of the outer housing 66A squeezes and secures the inner housing 66B inside the outer housing 66A to prevent rotation of the inner housing 66B with respect to the outer housing 66A.

As seen in FIG. 7, the outer housing 66A of the eccentric bearing assembly 66 is provided with a brake caliper 68A mounted thereto, while the center drive shaft 64 has a brake rotor 68B fixed thereto. The brake caliper 68A is fluidly connected to a master cylinder (not shown) which in turn is connected to the brake pedal. Operation of the brake pedal causes the brake caliper to squeeze the brake pads against the surface of the brake rotor 68B to slow or stop the off-highway vehicle 10.

The vehicle body 14 is constructed of one or more panels that is typically used in off-highway vehicles. The vehicle body 14 is provided with an air intake port 70 that is disposed forward of and above the radiator 38. In particular, the air intake port 70 is a low-drag air inlet in the form of a NACA duct. The air intake port 70 directs air towards the forward facing side of the radiator 38 so that outside air passes into the vehicle body 14 and through the radiator 38. Preferably, the vehicle body 14 is provide with an engine airbox cover 72 that over lies an airbox (not shown) provided on an inlet of the engine 32. The airbox collects air from outside and feeds it to intake hoses of each cylinder of the engine 32.

Turning to FIGS. 6 and 7, the rear suspension mechanisms 26R and 26L will be discussed in more detail. Basically, the rear suspension mechanisms 26R and 26L are double wishbone suspensions. The rear suspension mechanism 26R includes a lower right-rear suspension arm 80R, an upper right-rear suspension arm 82R and a right-rear shock absorber 84R. Similarly, the rear suspension mechanism 26L includes a lower left-rear suspension arm 80L, an upper left-rear suspension arm 82L and a left-rear shock absorber 84L. The rear suspension mechanism 26L is basically a mirror image of the rear suspension mechanism 26R. Thus, for the sake of brevity, only the rear suspension mechanism 26R is illustrated in detail herein.

The lower right-rear suspension arm 80R has an inboard end pivotally mounted to the frame 12 about a right-rear pivot axis RRP1, and an outboard end pivotally mounted to the rear wheel 16R. The upper right-rear suspension arm 82R has an inboard end pivotally mounted to the frame 12 about a right-rear pivot axis RRP2, and an outboard end pivotally mounted to the rear wheel 16R. The right-rear pivot axis RRP1 is parallel to the right-rear pivot axis RRP2. In this way, the lower right-rear suspension arm 80R and the upper right-rear suspension arm 82R are swingably (up and down). The right-rear shock absorber 84R has an upper end pivotally attached to the frame 12 and a lower end pivotally attached to the lower right-rear suspension arm 80R. Here, an outermost end of the drive source 30 is outboard of the right-rear pivot axis RRP1 and the right-rear pivot axis RRP2. Preferably, the engine of the drive source 30 is primarily (i.e., more than half) located outboard of the right-rear pivot axis RRP1 and the right-rear pivot axis RRP2. In the illustrated embodiment, the vertical position of the right-rear pivot axis RRP2 is adjustable. In particular, the frame 12 includes a pair of mounting brackets 86R for adjustably attaching the inboard end of the upper end of the upper right-rear suspension arm 82R. In particular, each of the mounting brackets 86R is provided with a plurality of mounting holes 88R for adjustably attaching the inboard end of the upper end of the upper right-rear suspension arm 82R. Likewise, the inboard end of the upper left-rear suspension arm 82L is also adjustably mounted to the frame 12 in the same manner by a pair of mounting brackets 86L (See FIG. 6).

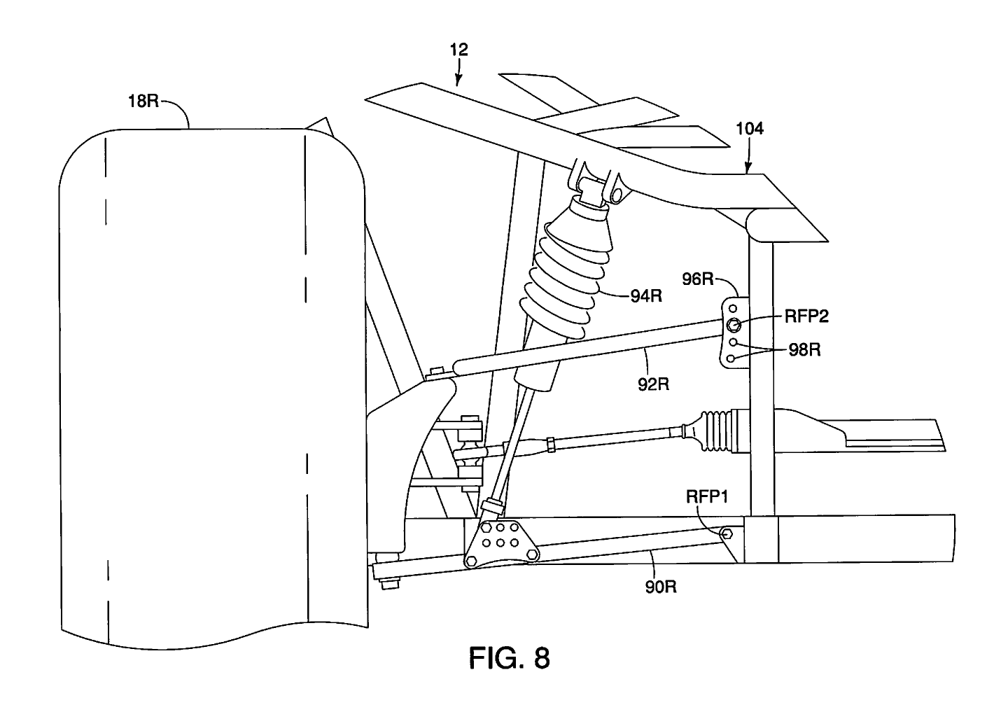

Turning to FIGS. 6 and 8, the front suspension mechanisms 28R and 28L will be discussed in more detail. Basically, the front suspension mechanisms 28R and 28L are double wishbone suspensions. The front suspension mechanism 28R includes a lower right-front suspension arm 90R, an upper right-front suspension arm 92R and a right-front shock absorber 94R. Similarly, the front suspension mechanism 28L includes a lower left-front suspension arm 90L, an upper left-front suspension arm 92L and a left-rear shock absorber 94L. The front suspension mechanism 28L is basically a mirror image of the front suspension mechanism 28R. Thus, for the sake of brevity, only the front suspension mechanism 28R is illustrated in detail herein.

The lower right-front suspension arm 90R has an inboard end pivotally mounted to the frame 12 about a right-front pivot axis RFP1, and an outboard end pivotally mounted to the front wheel 16F. The upper right-front suspension arm 92R has an inboard end pivotally mounted to the frame 12 about a right-front pivot axis RFP2, and an outboard end pivotally mounted to the front wheel 16F. The right-front pivot axis RFP1 is parallel to the right-front pivot axis RFP2. In this way, the lower right-front suspension arm 90R and the upper right-front suspension arm 92R are swingably (up and down). The right-front shock absorber 94R has an upper end pivotally attached to the frame 12 and a lower end pivotally attached to the lower right-front suspension arm 90R. Here, an outermost end of the drive source 30 is outboard of the right-front pivot axis RFP1 and the right-front pivot axis RFP2. Preferably, the engine of the drive source 30 is primarily (i.e., more than half) located outboard of the right-front pivot axis RFP1 and the right-front pivot axis RFP2. In the illustrated embodiment, the vertical position of the right-front pivot axis RFP2 is adjustable. In particular, the frame 12 includes a pair of mounting brackets 96R for adjustably attaching the inboard end of the upper end of the upper right-front suspension arm 92R. In particular, each of the mounting brackets 96R is provided with a plurality of mounting holes 98R for adjustably attaching the inboard end of the upper end of the upper right-front suspension arm 92R. Likewise, the inboard end of the upper left-front suspension arm 92L is also adjustably mounted to the frame 12 in the same manner by a pair of mounting brackets 96L (See FIG. 6).

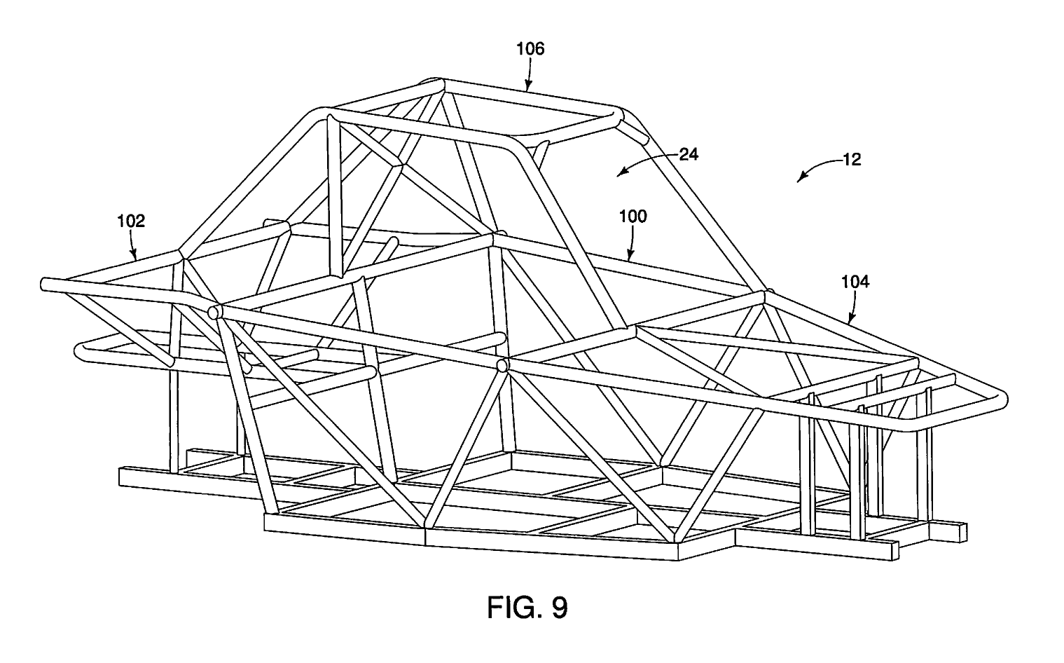

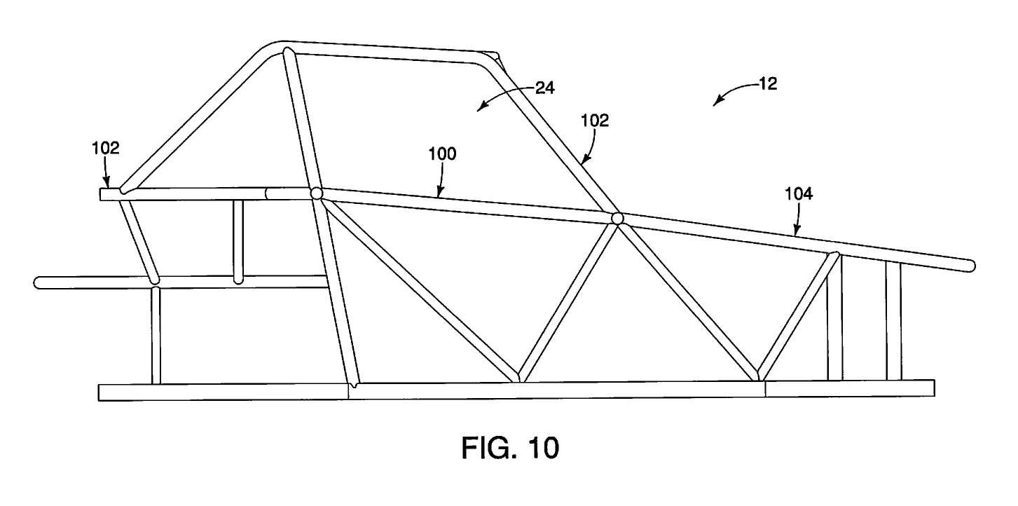

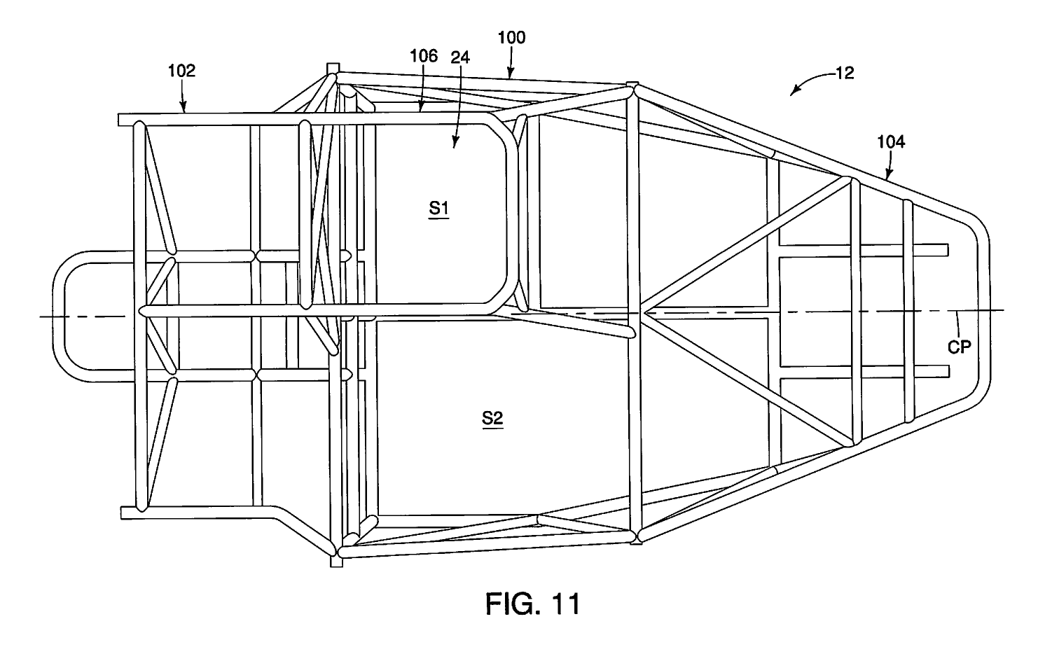

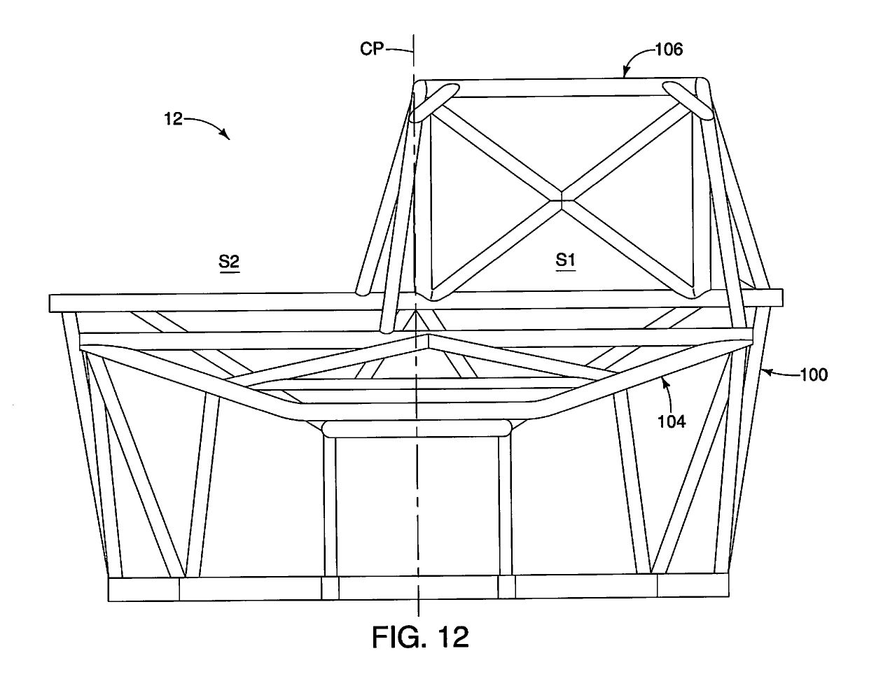

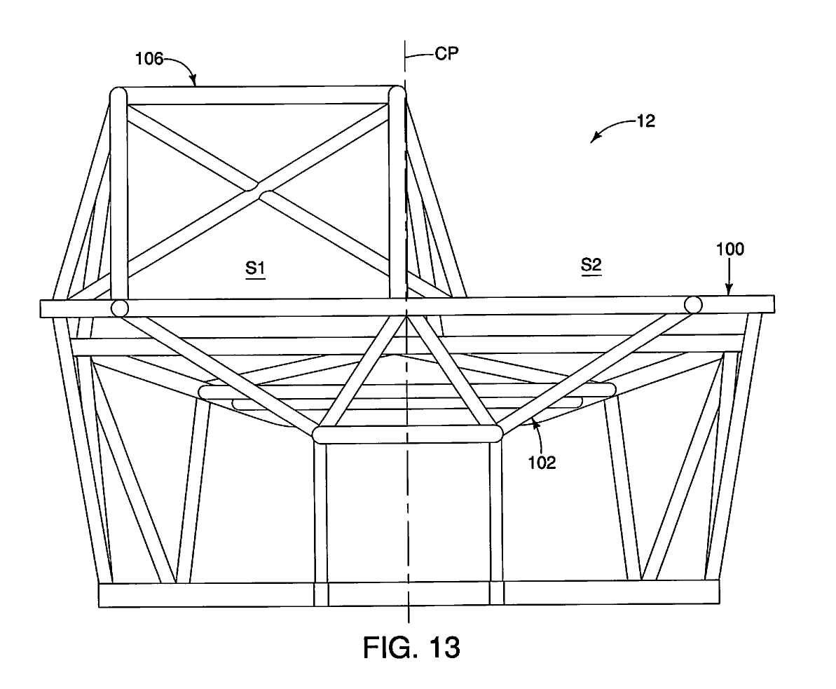

Turning to FIGS. 9 to 13, the frame 12 will be discussed in more detail. The frame 12 is an open tubular-type frame constructed of primarily of a plurality of tubular members that are fixed together by a conventional fastening technique such as welding. The frame 12 includes a center frame section 100, a rear frame section 102, a front frame section 104 and a pillar frame section 106. The pillar frame section 106 is on top of the center frame section 100 forming a roll cage above the seat 20. Thus, the frame 12 includes a roll cage above the seat 20. Preferably, the roll cage (the pillar frame section 106) is located only on the first lateral side S1 of the frame 12. A floorboard or floor panel (not shown) is fixed to at least the center frame section 100.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Thus, as used herein, the singular forms “a,” “an” and “the” are intended to include the plural forms as well, unless the context clearly indicates otherwise. Also, the terms “part,” “section,” “portion,” “member” or “element” when used in the singular can have the dual meaning of a single part or a plurality of parts. Unless otherwise defined, all terms (including technical and scientific terms) used herein have the same meaning as commonly understood by one of ordinary skill in the art to which illustrative embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Additionally, similar words used to describe the relationship between elements or layers should be interpreted in a like fashion (e.g., “between” versus “directly between”, “above” versus “directly above”, “below” versus “directly below”, “adjacent” versus “directly adjacent,” “on” versus “directly on”). Thus, components that are shown directly connected or contacting each other can have intermediate structures disposed between them unless specified otherwise.

It will be understood that, although the terms “first”, “second”, etc. may be used herein to describe various elements, components, regions, positions and/or sections, these elements, components, regions, positions and/or sections should not be limited by these terms. These terms are only used to distinguish one element, component, region, layer, position or section from another element, component, region, layer, position or section. Thus, a first element, component, region, position or section discussed above could be termed a second element, component, region, position or section without departing from the teachings of illustrative embodiments.

Spatially relative terms, such as “forward”, “rearward”, “above”, “below”, “beneath”, “downward”, “vertical”, “horizontal”, and “transverse” as well as any other similar spatial terms may be used herein for the ease of description to describe one element or feature's relationship to another element(s) or feature(s) of the above embodiments. These terms, as utilized to describe the present invention should be interpreted relative to an off-highway vehicle on a flat horizontal surface and with to a direction in which a driver looks straight when seated on a driver's seat in a straight forward driving direction. The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An off-highway vehicle comprising:
a frame having a longitudinal center plane extending in a vehicle lengthwise direction and dividing the frame into a first lateral side and a second lateral side;
a plurality of wheels supporting the frame, at least one of the wheels being a drive wheel;
a seat supported by the frame and located primarily on the first lateral side of the frame;
a drive source supported by the frame and located primarily on the second lateral side of the frame, the drive source having an output shaft oriented in a vehicle widthwise direction, the output shaft being arranged forward of a rearmost end of the seat and rearward of a frontmost end of the seat as viewed in a top plan view, the output shaft and an axle of the drive wheel are located on different axes; and
a drivetrain operatively coupling the output shaft to the drive wheel to transmit drive force from the output shaft to the drive wheel.

2. The off-highway vehicle according to claim 1, wherein
the output shaft extends from a side of the drive source that is located near the longitudinal center plane.

3. The off-highway vehicle according to claim 2, wherein
the output shaft extends towards the longitudinal center plane.

4. The off-highway vehicle according to claim 1, wherein
the drivetrain includes an endless band drive.

5. The off-highway vehicle according to claim 1, wherein
the axle of the drive wheel is adjustable in the vehicle lengthwise direction to adjust tension in an endless band of the endless band drive.

6. The off-highway vehicle according to claim 1, further comprising
a radiator disposed forward of a front side of the drive source, and aligned with the drive source in the vehicle lengthwise direction.

7. The off-highway vehicle according to claim 6, further comprising
a vehicle body supported on the frame, and having an air intake port disposed forward of and above the radiator.

8. The off-highway vehicle according to claim 1, further comprising
a fuel tank arranged rearward of the seat.

9. The off-highway vehicle according to claim 8, wherein
the fuel tank is arranged on the first lateral side of the longitudinal center plane of the frame.

10. The off-highway vehicle according to claim 8, wherein
the fuel tank is surrounded by the frame.

11. The off-highway vehicle according to claim 1, further comprising
a vehicle body supported on the frame, and defining a cabin located only on the first lateral side of the frame.

12. The off-highway vehicle according to claim 1, wherein
the frame includes a roll cage above the seat and located only on the first lateral side of the frame.

13. The off-highway vehicle according to claim 11, further comprising
an exhaust system extending generally rearward from a rear side of the drive source, the exhaust system having a muffler disposed rearward of the cabin.

14. The off-highway vehicle according to claim 1, further comprising
at least one left-rear suspension arm pivotally mounted to the frame about a left-rear pivot axis;
at least one right-rear suspension arm pivotally mounted to the frame about a right-rear pivot axis, an outermost end of the drive source being outboard of the right-rear pivot axis.

15. The off-highway vehicle according to claim 14, wherein
the at least one left-rear suspension arm includes a lower left-rear suspension arm and an upper left-rear suspension arm, and
the at least one right-rear suspension arm includes a lower right-rear suspension arm and an upper right-rear suspension arm.

16. The off-highway vehicle according to claim 15, wherein
the upper left-rear suspension arm has an inboard end adjustably attached to the frame to be adjusted in a vertical direction, and
the upper right-rear suspension arm has an inboard end adjustably attached to the frame to be adjusted in the vertical direction.

17. The off-highway vehicle according to claim 14, further comprising
at least one left-front suspension arm pivotally mounted to the frame about a left-front pivot axis; and
at least one right-front suspension arm pivotally mounted to the frame about a right-front pivot axis, an outermost end of the drive source being outboard of the right-rear pivot axis.

18. The off-highway vehicle according to claim 17, wherein
the at least one left-front suspension arm includes a lower left-front suspension arm and an upper left-front suspension arm, and
the at least one right-front suspension arm includes a lower right-front suspension arm and an upper right-front suspension arm.

19. The off-highway vehicle according to claim 18, wherein
the upper left-front suspension arm has an inboard end adjustably attached to the frame to be adjusted in a vertical direction, and
the upper right-front suspension arm has an inboard end adjustably attached to the frame to be adjusted in a vertical direction.

20. The off-highway vehicle according to claim 17, further comprising
at least one left-front suspension arm pivotally mounted to the frame about a left-front pivot axis; and
at least one right-front suspension arm pivotally mounted to the frame about a right-front pivot axis, an outermost end of the drive source being outboard of the right-front pivot axis.
